(19) United States
(12) Patent Application Publication
(10) Pub. No.: US 2025/0020337 A1
(43) Pub. Date: Jan. 16, 2025

(54) MOBILE APPARATUS INCLUDING AIR-CONDITIONING APPARATUS

(71) Applicants: Hyundai Motor Company, Seoul (KR); Kia Corporation, Seoul (KR); Hanon Systems, Daejeon (KR)

(72) Inventors: Yeong Jun Kim, Incheon (KR); Hochan An, Hwaseong-si (KR); Yeonho Kim, Seoul (KR); Jeawan Kim, Hwaseong-si (KR); Hoyoung Jeong, Hwaseong-si (KR); Man Hee Park, Suwon-si (KR); Jae Yeon Kim, Hwaseong-si (KR); Gwi Taek Kim, Cheonan-si (KR); Jae Hoon Kim, Daedeok-gu (KR)

(21) Appl. No.: 18/485,164

(22) Filed: Oct. 11, 2023

(30) Foreign Application Priority Data
Jul. 11, 2023 (KR) 10-2023-0089954

(51) Int. Cl. F24F 1/022; F24F 1/029; F24F 1/04

(52) U.S. Cl. CPC F24F 1/022; F24F 1/029; F24F 1/04; F24F 2221/42

(57) ABSTRACT

A mobile apparatus includes a mobile portion, a cabin housing that is mounted to the mobile portion and defines a first space and a second space, and an air-conditioning apparatus installed in the second space and configured to cool or heat the first space, where a compressor, a condenser, an expansion device, and an evaporator are modularized in the air-conditioning apparatus.

### CROSS-REFERENCE TO RELATED APPLICATION

This application claims priority to and the benefit of Korean Patent Application No. 10-2023-0089954, filed in the Korean Intellectual Property Office, on Jul. 11, 2023, the entire contents of which are incorporated herein by reference.

### TECHNICAL FIELD

The present disclosure relates to a mobile apparatus including an air-conditioning apparatus. More particularly, the present disclosure relates to, a mobile apparatus including an air-conditioning apparatus, in which a modularized air-conditioning apparatus is mounted in the mobile apparatus.

### BACKGROUND

Mobile apparatuses (e.g., mobile robots) may be used for unmanned autonomous delivery and may transport a diverse loaded items. For example, fresh food or refrigerated food may be transported through mobile apparatuses. In some cases, when delivering fresh food or refrigerated food through a mobile apparatus, a method of providing an insulating material inside the loading box and enclosing a cooling package such as an ice pack inside the loading box is used to prevent damage or deterioration of the loaded items. However, in this method, since it is difficult to maintain the internal temperature of the loading box at a low temperature when the external temperature is high, the temperature inside the loading box rises during the transport process, which causes a concern that the loaded items may deteriorate.

In some cases, a method of applying a thermal management system such as a thermoelectric element inside the loading box is used. Since the thermoelectric element has very low energy efficiency and consumes a lot of power, the consumption of the battery mounted on the mobile apparatus may increase and shorten a travel distance of the mobile apparatus.

### SUMMARY

The present disclosure attempts to provide a mobile apparatus including an air-conditioning apparatus capable of preventing fresh food or refrigerated food transported by the mobile apparatus from being damaged or deteriorated.

A mobile apparatus may include a mobile portion, a cabin housing mounted in the mobile portion, and forming a first space and a second space, and an air-conditioning apparatus installed in the second space, and configured to cool or heat the first space, where a compressor, a condenser, an expansion device, and an evaporator are modularized in the air-conditioning apparatus.

The cabin housing may include an outer case, and an inner case provided inside the outer case, and partitioning an interior space of the outer case into the first space and the second space.

A mobile apparatus may further include a loading door provided in the outer case and configured to selectively open and close the first space.

The air-conditioning apparatus may further include a base plate on which the compressor, the condenser, the expansion valve, and the evaporator are modularized.

The condenser and the evaporator may be disposed side by side adjacent to each other on the base plate.

A mobile apparatus may further include a condenser fan provided in the condenser, and an evaporator fan provided in the evaporator, where the condenser fan and the evaporator fan are provided on opposite sides of an inner case.

The compressor may be provided on an opposite side of the condenser fan and the evaporator fan with respect to the inner case.

A mobile apparatus may further include a condenser duct detachably provided in the condenser fan and communicating with an outlet formed in an outer case.

A mobile apparatus may further include an evaporator duct detachably provided in the evaporator fan and communicating with the first space.

A mobile apparatus may further include a heater core that is provided in the first space, provided in the evaporator exposed to the first space, or provided in the evaporator duct.

A mobile apparatus may further include a ventilation door provided in the evaporator duct, where the ventilation door is opened in conjunction with a loading door.

When the ventilation door is opened, the evaporator fan may be operated.

The air-conditioning apparatus may include a first refrigerant line on which the compressor is disposed, a second refrigerant line on which the condenser, the expansion device, and the evaporator are disposed, and a 4-way valve installed at a location where the first refrigerant line and the second refrigerant line cross, where, according to an operation of the 4-way valve, the condenser may be configured to selectively operate as the evaporator, and the evaporator may be configured to selectively operate as the condenser.

The expansion device is a two-way expansion valve.

In some implementations, a mobile apparatus, a modularized air-conditioning apparatus is mounted in a mobile apparatus, and thereby items transported by the mobile apparatus may be maintained at an appropriate temperature.

### BRIEF DESCRIPTION OF THE DRAWINGS

FIG. 1 is a perspective view showing an example configuration of a mobile apparatus including a refrigeration module.

FIG. 2 is a perspective view showing an example configuration of a cabin housing.

FIG. 3 is a exploded perspective view showing an example configuration of a cabin housing and air-conditioning apparatus.

FIG. 4 and FIG. 5 are perspective views showing an example configuration of a cabin housing from which a loading door is removed.

FIG. 6 is a perspective views showing an example configuration of an outer case.

FIG. 7 is a perspective view showing an example configuration of an inner case.

FIG. 8 is a perspective view showing an example configuration of the air-conditioning apparatus.

FIG. 9 is a top plan view showing an example configuration of the air-conditioning apparatus.

FIG. 10 is a rear view showing an example configuration of the air-conditioning apparatus.

FIG. 11 is a cooling circuit diagram showing an example configuration of the air-conditioning apparatus.

FIG. 12A and FIG. 12B are perspective views showing an example configuration of an air-conditioning apparatus.

FIG. 13A and FIG. 13B are cooling circuit diagrams showing an example configuration of an air-conditioning apparatus.

FIG. 14 is a drawing showing an example configuration of an air-conditioning apparatus.

FIG. 15 is a chart showing an example operation of an air-conditioning apparatus.

### DETAILED DESCRIPTION

Hereinafter, a mobile apparatus including an air-conditioning apparatus is described in detail with reference to the drawings.

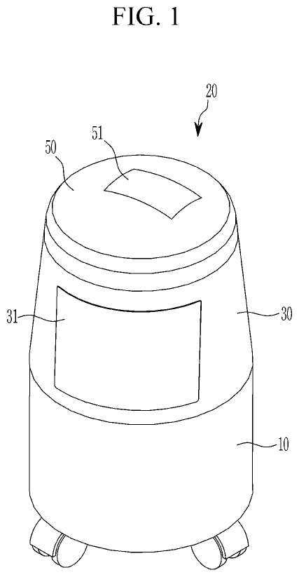

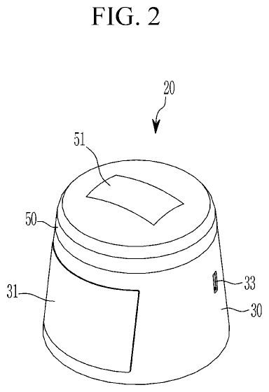

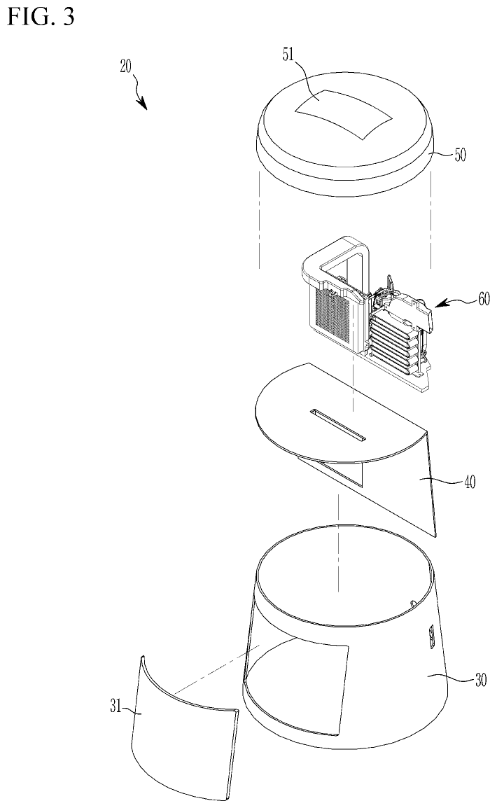

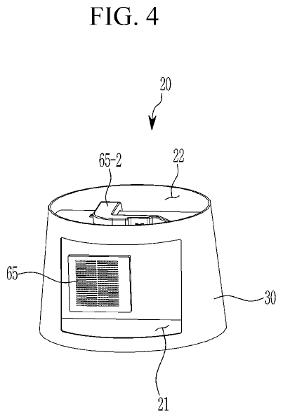

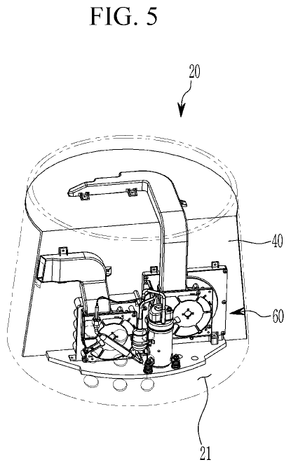

FIG. 1 is a perspective view showing an example configuration of a mobile apparatus including a refrigeration module. FIG. 2 is a perspective view showing an example configuration of a cabin housing. FIG. 3 is a exploded perspective view showing an example configuration of a cabin housing and air-conditioning apparatus. FIG. 4 and FIG. 5 are perspective views showing an example configuration of a cabin housing from which a loading door is removed.

In some implementations, as shown in FIG. 1 to FIG. 5, a mobile apparatus can include a mobile portion 10, a cabin housing 20 mounted to the mobile portion 10, and an air-conditioning apparatus 60 provided inside the cabin housing 20.

For example, the mobile portion 10 can include a mobile robot, and the mobile robot may be a wheel-based mobile robot, but the scope of the present disclosure is not limited thereto, and for example, the mobile robot may be a leg-driven robot.

The cabin housing 20 is mounted on the upper portion of the mobile portion 10, and the air-conditioning apparatus 60 is provided inside the cabin housing 20. A mounting space formed inside the cabin housing 20 may be cooled or heated by the air-conditioning apparatus 60.

The cabin housing 20 may include an outer case 30 and an inner case 40 provided inside the outer case 30. In some examples, the cabin housing 20 may further include an upper case 50 provided on top of the outer case 30.

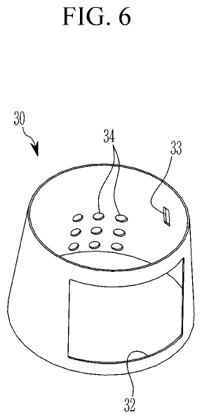

Referring to FIG. 6, the outer case 30 forms the external appearance of the cabin housing 20, and an interior space is formed therein. The interior space of the outer case 30 is divided into a loading space and an installation space by the inner case 40. This will be described later.

The outer case 30 is formed in a substantially cylindrical shape. The upper portion of the outer case 30 may be opened. In some examples, the outer case 30 may be provided with a loading door 31 that selectively opens and closes the interior space. When the loading door 31 is opened or closed, the loading space inside the outer case 30 may be opened or closed from the outside. An inlet 32 selectively opened by the loading door 31 and an outlet 33 through which air heated by a condenser 63 of the air-conditioning apparatus 60 is discharged may be formed in the outer case 30. In some examples, at least one penetration hole 34 may be formed to discharge air of the installation space heated by the operation of the air-conditioning apparatus 60 to the outside. Here, the outlet 33 may be formed on a first side surface of the outer case 30, and the penetration hole 34 may be formed on a second side surface of the outer case 30.

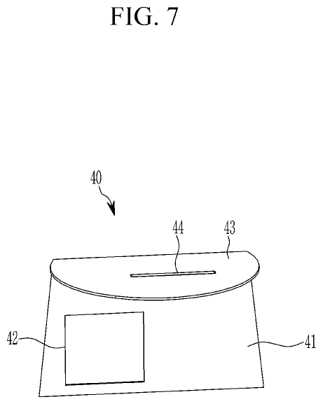

Referring to FIG. 7, as described above, the inner case 40 is provided in the interior space of the outer case 30, and divides the interior space of the outer case 30 into a first space 21 and a second space 22. For this purpose, the inner case 40 may include an inner body 41, and an upper body 43 provided on top of the inner body 41.

The inner body 41 is formed in a substantially plate shape and installed vertically inside the outer case 30, to partition the interior space of the outer case 30 into the first space 21 and the second space 22. The first space 21 is the loading space where items (articles) are loaded, and the second space 22 is the installation space where the air-conditioning apparatus 60 is installed. An evaporator mounting hole 42 is formed in the inner body 41 such that an evaporator 65 is exposed to the first space 21. The evaporator mounting hole 42 is formed in a shape corresponding to that of the evaporator 65.

The upper body 43 may be provided perpendicularly to the inner body 41 at the top of the inner body 41. The upper body 43 blocks the open top of the outer case 30. An evaporator duct hole 44 communicating with an evaporator duct 65-2 to be described later is formed in the upper body 43.

A display device such as a light emitting diode (LED) may be provided on the upper case 50, and an operating state of the mobile apparatus including the air-conditioning apparatus 60 may be displayed through the display device.

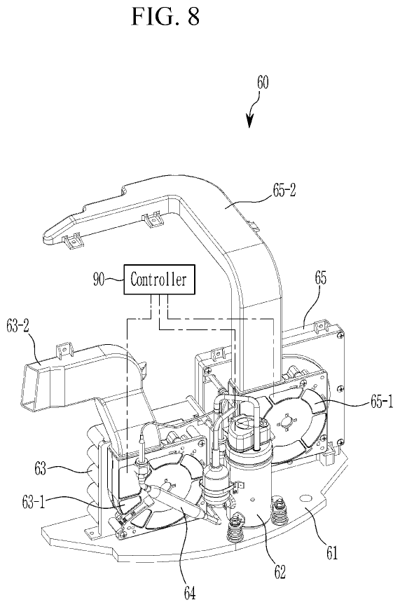

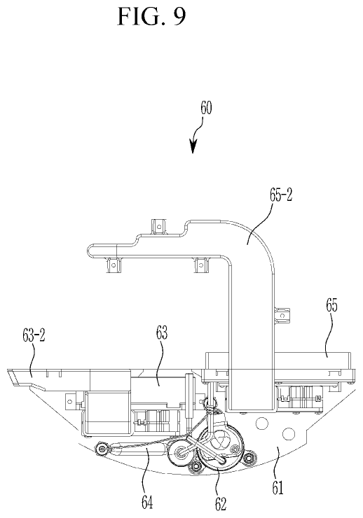

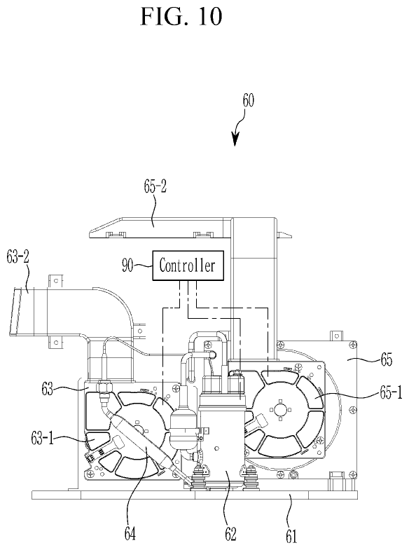

In some implementations, referring to FIG. 8 to FIG. 11, the air-conditioning apparatus 60 can include a base plate 61, a compressor 62 provided on the base plate 61, the condenser 63 provided on the base plate 61, an expansion device 64 provided on the base plate 61, and the evaporator 65 provided on the base plate 61. In the present disclosure, the air-conditioning apparatus 60 is configured such that the compressor 62, the condenser 63, the expansion device 64 and the evaporator 65 are modularized on top of the base plate 61. To this end, the condenser 63 and the evaporator 65 are disposed side by side adjacent to each other on the base plate 61.

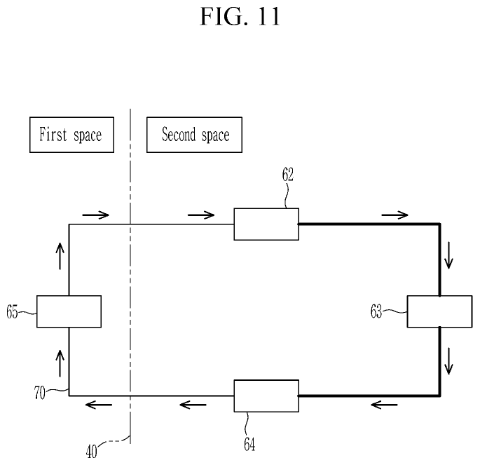

The compressor 62, the condenser 63, the expansion device 64, and the evaporator 65 are sequentially disposed along a refrigerant line 70 through which a heat-exchange medium (for example, refrigerant) flows (refer to FIG. 11), and the heat-exchange medium (for example, refrigerant) discharged by the operation of the compressor 62 circulates through the condenser 63, expansion device 64 (for example, expansion valve), and the evaporator 65 and then circulates back to the compressor 62. In this process, heat is exchanged through the evaporator 65 between the refrigerant and the interior air in the first space 21, and as a result, the air-conditioning apparatus 60 may cool the first space 21 (or the loading space). That is, in the air-conditioning apparatus 60, the high-temperature and high-pressure gaseous refrigerant compressed by the compressor 62 is condensed by the condenser 63, passes through the expansion device 64, and evaporated in the evaporator 65, to lower temperature and humidity of the first space 21 (alternatively, the loading space).

The evaporator 65 is provided with an evaporator fan 65-1, and the condenser 63 is provided with a condenser fan 63-1. The evaporator fan 65-1 and the condenser fan 63-1 are operated by a control signal from a controller 90. The controller 90 may be implemented with one or more processors that operate according to a predetermined program, and program instructions programmed to perform each step of controlling the mobile apparatus according to the present disclosure through the one or more processors are stored in the memory of the controller 90.

The evaporator fan 65-1 and the condenser fan 63-1 are provided on the opposite sides of the inner body 41 of the inner case 40. And the compressor 62 is provided on opposite sides of the condenser fan 63-1 and the evaporator fan 65-1 with respect to the inner case. In other words, the evaporator 65 and the condenser 63 are disposed to face the inner body 41 of the inner case 40, the evaporator 65 and the evaporator duct 65-2 are disposed to face each other, and the condenser 63 and a condenser duct 63-2 are disposed to face each other. Accordingly, within the second space 22, the inner body 41 of the inner case 40, the evaporator 65 and the condenser 63, the evaporator fan 65-1 and the condenser fan 63-1, and the compressor 62 are sequentially disposed, such that the compressor 62 is positioned farthest from the first space 21. Since the compressor 62 is positioned farthest from the first space 21, transmission of vibration and noise generated from the compressor 62 to the first space 21 may be minimized.

An evaporator duct 65-2 is detachably provided in the evaporator fan 65-1. The evaporator duct 65-2 has a first side connected to the evaporator fan 65-1, and a second side communicating with the evaporator duct hole 44 formed in the upper body 43 of the inner case 40. Accordingly, the air cooled by heat-exchange with the refrigerant in the evaporator 65 is circulated into the first space 21 through the evaporator duct 65-2 by the operation of the evaporator fan 65-1.

The condenser duct 63-2 is detachably provided in the condenser fan 63-1. The condenser duct 63-2 has a first side connected to the condenser fan 63-1, and a second side communicating with the outlet 33 formed in the outer case 30. Accordingly, the air heated by the condenser 63 is discharged to the outside of the cabin housing 20 through the condenser duct 63-2 by the operation of the condenser fan 63-1. In addition, external air flows into the installation space of the cabin housing 20 through the penetration hole formed in the outer case 30 and discharged to the outlet 33 through the condenser duct 63-2, and thereby air-flow for cooling the condenser 63 of the air-conditioning apparatus 60 may be smooth.

At this time, the outlet 33 is formed on the first side surface of the outer case 30 adjacent to the condenser 63, and the penetration hole 34 is formed on the second side surface of the outer case 30 adjacent to the condenser 63. The condenser duct 63-2 connects the condenser fan 63-1 and the outlet 33. The evaporator duct 65-2 connects the evaporator fan 65-1 disposed adjacent to the condenser 63 and the evaporator duct hole 44 formed in the upper body 43 of the inner case 40. Accordingly, the condenser duct 63-2 and the evaporator duct 65-2 are disposed so as not to cause interference with each other within the second space 22. Accordingly, the flow of air moving along the penetration hole 34, the second space 22, the condenser fan 63-1, the condenser duct 63-2, and the outlet 33, and the flow of air moving along the second space 22, the evaporator fan 65-1, the evaporator duct 65-2, and the first space 21 are minimized from mixing with each other.

As described above, the modularized air-conditioning apparatus 60 is mounted in the second space 22 (alternatively, the installation space) of the cabin housing 20. Modularization of the air-conditioning apparatus 60 allows the modularized air-conditioning apparatus 60 to be mounted on various types of mobile apparatuses. That is, since the air-conditioning apparatus 60 of the same specification may be mounted on mobile apparatuses of various types (or specifications), the air-conditioning apparatus 60 may have versatility. In addition, since the evaporator duct 65-2 is detachably provided in the evaporator fan 65-1 and the condenser duct 63-2 is detachably provided in the condenser fan 63-1, modularization of the air-conditioning apparatus 60 may be easy and efficient.

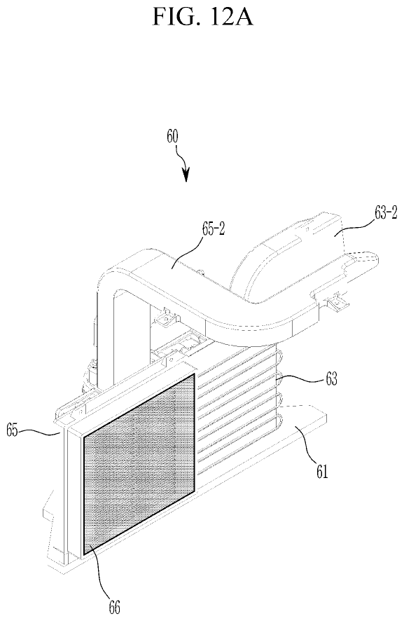

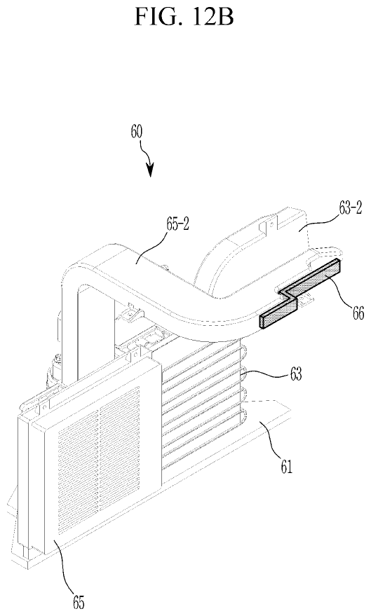

FIG. 12A and FIG. 12B are perspective views showing an example configuration of the air-conditioning apparatus 60.

Referring to FIG. 12A and FIG. 12B, the air-conditioning apparatus 60 may further include a heater core 66 installed adjacent to the evaporator 65.

An install position of the heater core 66 may be installed on a surface of the evaporator 65 facing the first space 21, or installed in the evaporator duct 65-2. Alternatively, the heater core 66 may be installed inside the first space 21. Some or all of the air having passed through the evaporator 65 may be discharged to the first space 21 after passing through the heater core 66, and thus the interior temperature of the first space 21 may be adjusted to a predetermined temperature. The heater core 66 may use electricity as an energy source.

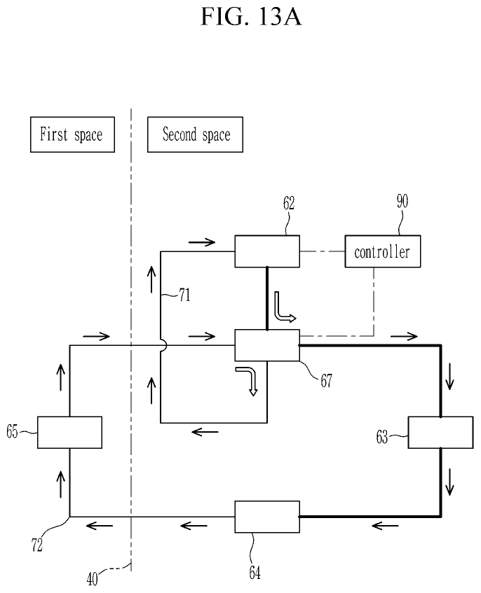

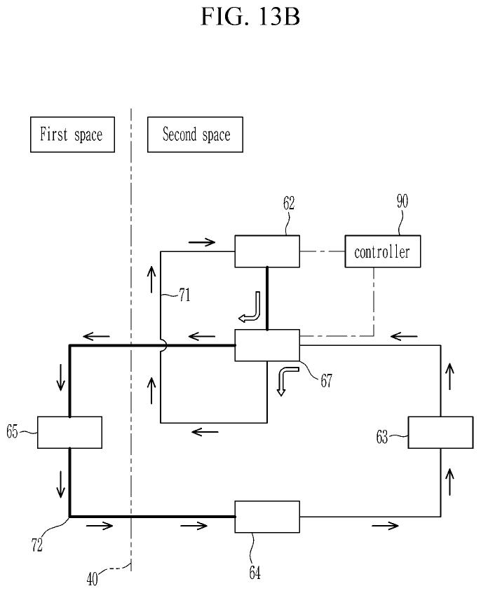

FIG. 13A and FIG. 13B are cooling circuit diagrams showing an example configuration of the air-conditioning apparatus 60.

Referring to FIG. 13A and FIG. 13B, the condenser 63 of the air-conditioning apparatus 60 may selectively operate as an evaporator, and the evaporator 65 may selectively operate as a condenser.

To this end, the air-conditioning apparatus 60 may include a first refrigerant line 71 through which the refrigerant flows and on which the compressor 62 is disposed, the condenser 63 which the refrigerant flows and which selectively operates as an evaporator, the expansion device 64, a second refrigerant line 72 on which the evaporator 65 selectively operating as a condenser is disposed, and a 4-way valve 67 installed at a location where the first refrigerant line 71 and the second refrigerant line 72 cross. Here, the expansion device 64 may be, for example, a bidirectional expansion valve that expands the refrigerant in both directions.

According to an operation of the 4-way valve 67, the air-conditioning apparatus 60 may operate in a cooling mode (refer to FIG. 13A) for cooling the first space 21, and a heating mode (refer to FIG. 13B) for heating the first space 21. The 4-way valve 67 may be operated by a control signal from the controller 90.

In the cooling mode (refer to FIG. 13A), by the operation of the 4-way valve 67, the refrigerant compressed at the compressor 62 flows along the 4-way valve 67, the condenser 63, the expansion device 64, the evaporator 65, and the 4-way valve 67, and then back to the compressor 62.

In the heating mode (refer to FIG. 13B), by the operation of the 4-way valve 67, the refrigerant compressed at the compressor 62 flows along the evaporator 65 operating as a condenser, the expansion device 64, the condenser 63 operating as a evaporator, and the 4-way valve 67, and then back to the compressor 62.

In this way, the heating mode may be implemented by using the parts that implement the existing cooling mode, by applying the 4-way valve 67.

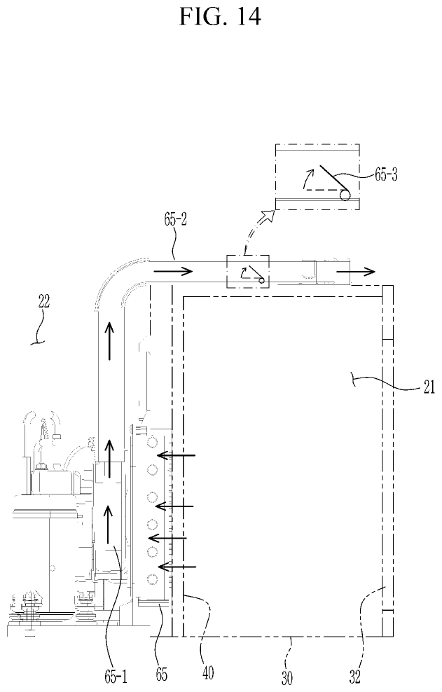

FIG. 14 is a drawing showing an example configuration of an air-conditioning apparatus.

Referring to FIG. 14, a ventilation door 65-3 is provided in the evaporator duct 65-2 of the air-conditioning apparatus 60. The ventilation door 65-3 may be opened or closed by a control signal from a controller.

The ventilation door 65-3 may be operated in conjunction with the loading door 31. For example, the ventilation door 65-3 may be opened when the loading door 31 is opened, and the ventilation door 65-3 may be closed when the loading door 31 is closed.

When the loading door 31 is opened, the ventilation door 65-3 is also opened, and the evaporator fan 65-1 is also operated. Therefore, when the loading door 31 is opened, the external air introduced through the loading door 31 is discharged to the outside through the opened ventilation door 65-3 provided in the evaporator duct 65-2 by the operation of the evaporator fan 65-1 by the control signal of the controller 90. Through this, the inside of the loading space may be ventilated.

Meanwhile, in the air-conditioning apparatus 60, when the temperature of the first space 21 reaches a target temperature, speeds of the compressor 62, the evaporator fan 65-1, and the condenser fan 63-1 may be variable adjusted. The operation of the compressor 62, the evaporator fan 65-1, and the condenser fan 63-1 may be controlled by control signals of the controller.

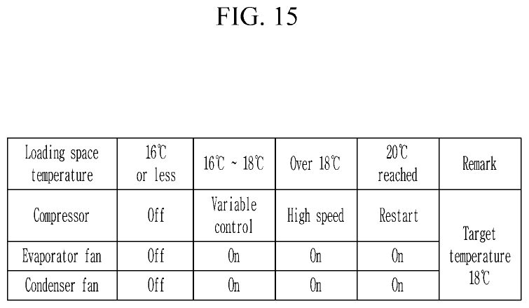

For example, referring to FIG. 15, in the case that the target temperature of the first space 21 is 18 degrees Celsius, when the temperature of the first space 21 exceeds the 18 degrees Celsius, the compressor 62 operates at a high speed, and the evaporator fan 65-1 and the condenser fan 63-1 also operate. When the temperature of the first space 21 is between 18 degrees Celsius and 16 degrees Celsius, the speed of the compressor 62 is variably controlled, and the evaporator fan 65-1 and the condenser fan 63-1 also operate. When the temperature of the first space 21 is 16 degrees Celsius or less, the compressor 62, the evaporator fan 65-1, and the condenser fan 63-1 are all turned off. When the temperature of the first space 21 reaches 20 degrees Celsius, the compressor 62 is restarted, and the evaporator fan 65-1 and the condenser fan 63-1 also operate.

As such, by variably controlling the speed of the compressor 62 after the temperature of the first space 21 reaches the target temperature, power consumption of the air-conditioning apparatus 60 may be minimized.

According to a mobile apparatus as described above, when fresh food or refrigerated food is delivered by the mobile apparatus, the freshness of the loaded items may be maintained and the appropriate temperature for delivering the loaded items may be maintained.

In addition, after delivery of the loaded items is completed, the smell of the loaded items remaining in the first space 21 may be removed through a ventilation function. Through this, it is possible to prevent the smell of previously delivered loaded items from being mixed with currently delivered loaded items.

Although the exemplary implementation of the present disclosure has been described, the present disclosure is not limited thereto, and it is possible to carry out various modifications within the scope of the claims, the detailed description of the disclosure, and the accompanying drawings, and the modifications belong to the scope of the present disclosure as a matter of course.

What is claimed is:

1. A mobile apparatus, comprising:
a mobile portion implemented as a mobile robot;
a cabin housing that is disposed at the mobile portion and defines a first space and a second space; and
an air-conditioning apparatus disposed in the second space of the cabin housing and configured to cool or heat the first space of the cabin housing,
wherein the air-conditioning apparatus comprises a compressor, a condenser, an expansion device, and an evaporator.

2. The mobile apparatus of claim 1, wherein the cabin housing comprises:
an outer case; and
an inner case that is disposed inside the outer case and partitions an interior space of the outer case into the first space and the second space.

3. The mobile apparatus of claim 2, further comprising a loading door disposed at the outer case and configured to open and close the first space of the cabin housing.

4. The mobile apparatus of claim 1, wherein the air-conditioning apparatus further comprises a base plate that supports the compressor, the condenser, the expansion device, and the evaporator.

5. The mobile apparatus of claim 4, wherein the condenser and the evaporator are arranged side by side adjacent to each other on the base plate.

6. The mobile apparatus of claim 5, further comprising:
a condenser fan disposed at the condenser; and
an evaporator fan disposed at the evaporator,
wherein the cabin housing comprises an inner case disposed inside the cabin housing, and
wherein the condenser fan and the evaporator fan are disposed at opposite sides of the inner case.

7. The mobile apparatus of claim 6, wherein the compressor is disposed at one side of the condenser fan and the evaporator fan and spaced apart from the inner case.

8. The mobile apparatus of claim 6, wherein the cabin housing comprises an outer case that defines an outlet in fluid communication with the condenser, and
wherein the mobile apparatus further comprises a condenser duct detachably disposed at the condenser fan and in fluid communication with the outlet defined at the outer case.

9. The mobile apparatus of claim 6, further comprising an evaporator duct that is detachably disposed at the evaporator fan and in fluid communication with the first space of the cabin housing.

10. The mobile apparatus of claim 9, further comprising a heater core that is disposed in the first space of the cabin housing, the heater core being disposed at a portion of the evaporator exposed to the first space or disposed at the evaporator duct.

11. The mobile apparatus of claim 9, further comprising:
a loading door configured to open and close the first space of the cabin housing; and
a ventilation door disposed the evaporator duct and configured to be opened based on operation of the loading door.

12. The mobile apparatus of claim 11, wherein the ventilation door is configured to:
be opened based on the loading door being opened; and
be closed based on the loading door being closed.

13. The mobile apparatus of claim 11, wherein the evaporator fan is configured to operate based on the ventilation door being opened.

14. The mobile apparatus of claim 4, wherein the air-conditioning apparatus comprises:
a first refrigerant line, wherein the compressor is disposed at the first refrigerant line;
a second refrigerant line, wherein the condenser, the expansion device, and the evaporator are disposed at the second refrigerant line; and
a 4-way valve disposed at a position connected to the first refrigerant line and the second refrigerant line, and
wherein the 4-way valve is configured to operate the condenser to perform an evaporator function and to operate the evaporator to perform a condenser function.

15. The mobile apparatus of claim 14, wherein the expansion device comprises a two-way expansion valve.

16. The mobile apparatus of claim 1, wherein the mobile portion comprises at least one of a wheel or a leg.

17. The mobile apparatus of claim 1, wherein the cabin housing is disposed above the mobile portion and covers an upper portion of the mobile portion.
